(19) United States
(12) Patent Application Publication
(10) Pub. No.: US 2016/0104234 A1
(43) Pub. Date: Apr. 14, 2016

(54) Data Exchange Infrastructure

(71) Applicant: Tom McDonald, San Carlos, CA (US)

(72) Inventor: Tom McDonald, San Carlos, CA (US)

(21) Appl. No.: 14/512,938

(22) Filed: Oct. 13, 2014

(51) Int. Cl. G06Q 30/06

(52) U.S. Cl. CPC G06Q 30/0641

(57) ABSTRACT

A method and system for executing an item transaction between a first endpoint and a second endpoint employ a transaction application running on a computing device. The item may be any suitable item, such as a vehicle, and the computing device may be any suitable device having a graphical user interface and one or more input functions. The method and system entail receiving item data at the transaction application from the first endpoint and preparing a listing associated with the item at the transaction application and exposing the listing while omitting a contact channel. After a verification and compensation process are executed relative to the item and the first endpoint, then a contact channel is opened between the first endpoint and the second endpoint so as to enable communications between the first endpoint and the second endpoint.

### TECHNICAL FIELD

The disclosure pertains to network communications, and more particularly pertains to a system and method for safely and easily exchanging and verifying data related to an item transaction.

### BACKGROUND

While today's marketplace is truly a global marketplace, there are still instances related to remote transactions where information asymmetry leads to an unbalanced transaction; in particular, if the information asymmetry is appreciated by both endpoints, then an uncertainty discount, generally more than warranted, is almost inevitably built into the transaction, whereas if the information asymmetry is known only to one endpoint, then the risk will be borne solely by the other endpoint. With both of these outcomes being undesirable, the supply of goods for exchange shrinks, and as such, the market is inefficient or “broken.”

The rise of Internet-based communications and online listing services has only exacerbated the inefficiencies. Free listing services offer little validation as to the identity of the seller, and can become havens for deceptive practices such as the cloning of identification numbers from higher-quality cars and odometer tampering. Some systems provide the legal history of a vehicle (reported accidents, title changes) but do little to provide insight into the condition of the vehicle at the time of sale. A vehicle could be currently damage-free, but may still pose a financial risk to future buyers because the owner failed to maintain the vehicle properly.

While the present disclosure is directed to a system that may eliminate the shortcomings noted in this Background section, it should be appreciated that such benefits are not necessarily limitations on the scope of the disclosed principles or of the attached claims, except to the extent expressly recited in a claim. Additionally, the discussion of technology in this Background section is reflective of inventor observations or considerations, and is not intended to be admitted or assumed prior art as to the discussed details.

Moreover, the identification of the desirability of a certain course of action is the inventors' observation, and should not be assumed to be an art-recognized desirability. The citation of references is not intended to provide a broad and inclusive summary of the references, and nothing in the foregoing is intended to conclusively characterize any reference. Rather, only the references themselves are art, and this section is expressly disclaimed as art, prior or otherwise.

### SUMMARY OF THE DISCLOSURE

In an embodiment of the disclosed principles, a method is given for executing an item transaction between a first endpoint and a second endpoint via a transaction application running on a computing device. The item may be any suitable item, such as a vehicle, and the computing device may be any suitable device having a graphical user interface and one or more input functions. The method entails receiving data associated with the item to be subject to the transaction at the transaction application from the first endpoint and preparing a listing associated with the item at the transaction application and posting the listing while omitting a contact channel from the posting. After a verification and compensation process are executed relative to the item and the first endpoint, then a contact channel is opened between the first endpoint and the second endpoint so as to enable communications between the first endpoint and the second endpoint.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a system schematic showing a system usable in accordance with embodiments of the disclosed principles to enable a transaction between endpoints;

FIG. 2 is a flow chart showing a process in accordance with embodiments of the disclosed principles for preparing an item listing; and

FIG. 3 is a flow chart showing a process in accordance with embodiments of the disclosed principles for utilizing an item listing.

### DETAILED DESCRIPTION

As noted above, current systems do little to increase the safety and efficiency of remote transactions related to large goods such as automobiles. The disclosed principles herein provide a connected service that facilitates secure transactions of such large items between endpoints (e.g., buyer and seller).

In overview, an electronically connected nationwide network of verifiers (e.g., vetted, premium auto service shops) is configured to pre-screen items such as vehicles before they are listed for sale, validate buyer and seller identification, ownership and insurance, and to administer an inspection protocol. With listings vetted before becoming available online, and with a full inspection (e.g., of an undercarriage) immediately after a transaction amount is set, the system maximizes trust and transparency between end points. With convenient, secure electronic communication between end points and verifiers, the process creates a level of confidence in the endpoints.

In short, in an embodiment, a system in accordance with the disclosed principles provides electronic, pre-screening of items before publication, a physical pre-screen before end points are put into contact, and a comprehensive, independent inspection prior to a transaction.

The disclosed system employs a remote application and a corresponding online database with specific qualifying and scheduling features as sited above, secure 3-way communications between car owners, prospective buyers and select service shop partners for messaging and scheduling. The service can be fronted by an HTML web-based interface or a mobile application.

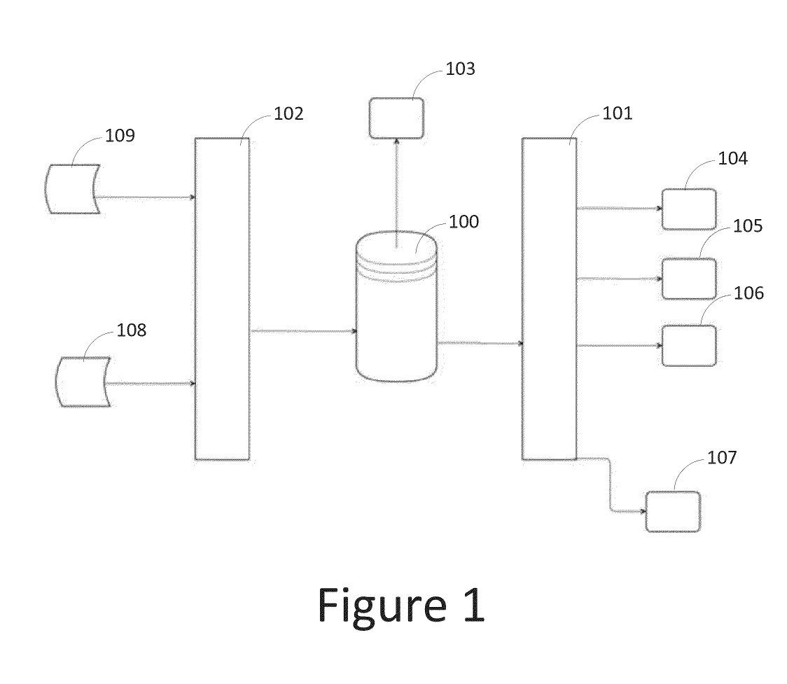

The secure, online database includes a plurality of administrative tools and supports different administrative levels, e.g., for employees and service shop partners. The database will include data associated with vehicle listings, endpoint registration information, seller preferences, and service shop partner information. Location-based services assist endpoints in identifying a closest partnered service location. A separate API allows different clients (web, apps) to connect with the service, improving efficiency and security. The database also connects with third-party application-programming interfaces for scheduling and vehicle information services. The server architecture diagram is shown in FIG. 1 of the attached drawings.

As can be seen, the server architecture includes a primary database 100, that is accessed via client connection APIs 101 and third party connection APIs 102. In addition, the primary database 100 is accessed via admin channels 103 in an embodiment. Any number of devices and entities may access the primary database 100 via the client connection APIs 101. In the illustrated example, these devices and entities include an iOS or Android mobile application (104), an HTML 5.0 mobile application (105) or the like, and an internet based application (Web App) 106. A service provider access module 107 may also be provided, allowing a service partner such as a service station to access the primary database 100.

As noted above, the third party connection APIs 102 allow third parties to access the primary database 100. Such third parties could include, for example, Edmunds 108 or Crowd Clock 109.

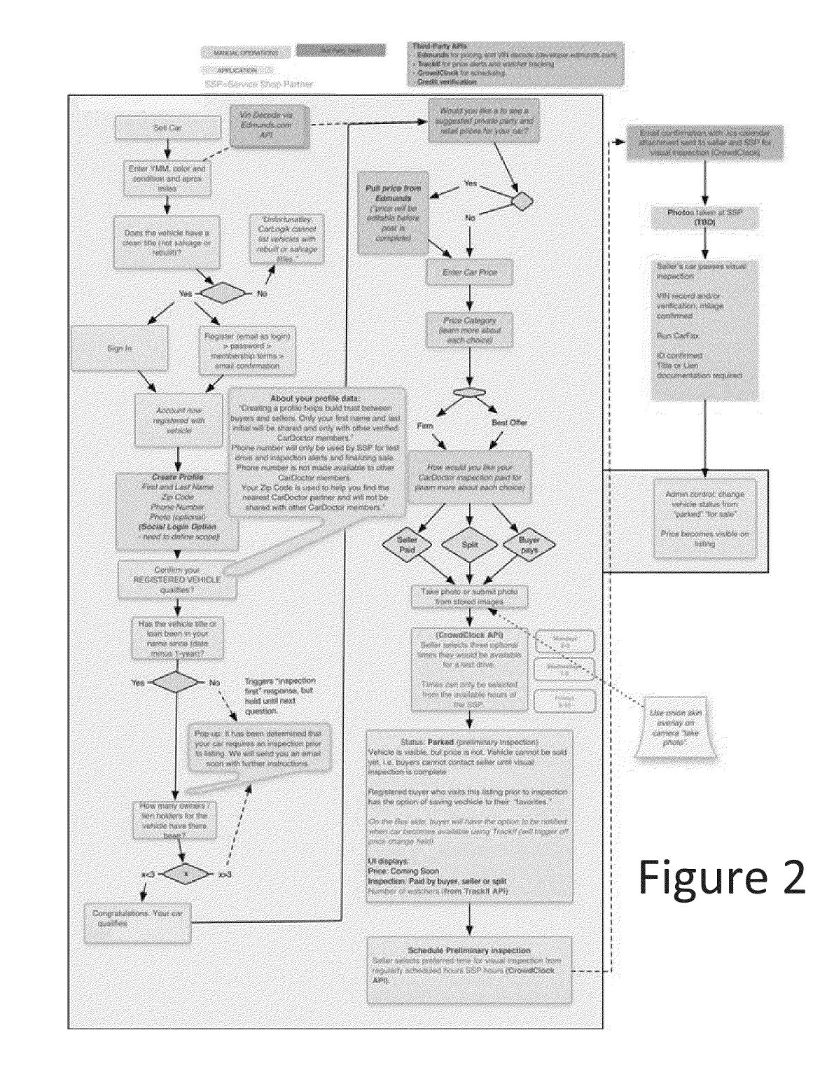

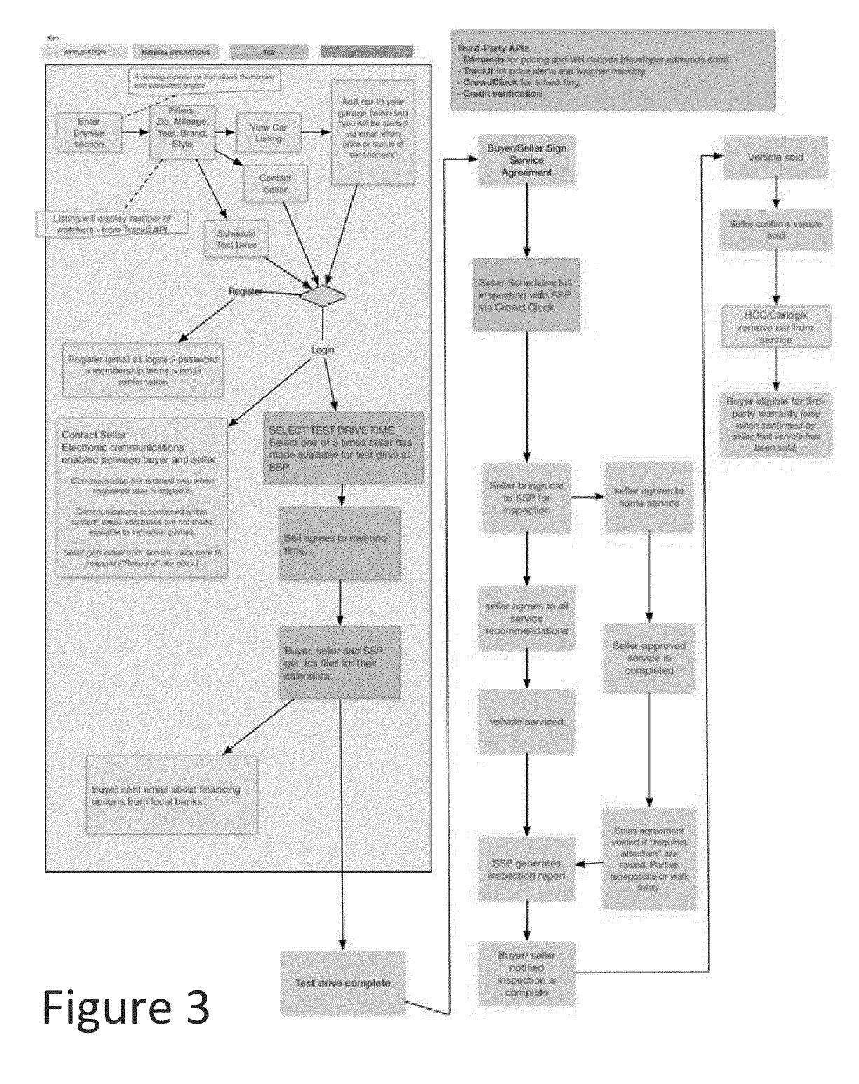

The flow chart of FIG. 2 shows an exemplary process executed by the application for listing an item associated with an endpoint for a possible transaction, while the flow chart of FIG. 3 shows an exemplary process executed by the application for allowing viewing of an item and initiating a transaction by an endpoint. In both processes, the GUI messages presented by the application are shown in double outlines while the process steps are shown in single outline.

As can be seen, the process of FIG. 2 takes input from the user interface, e.g., key punches, as well as from third party sources, and outputs data to a user via a screen of a device running the application. The device may be a computer, a mobile device such as a smart phone, or any other suitable device.

The process of FIG. 3, executed by the application, interacts with third party applications and entities to complete a transaction between endpoints.

In the listing process, the providing endpoint (e.g., Seller) self-qualifies on the application or a website as to clean title, number of owners, length of ownership and so on. The SSP can override if the condition of the item is very good in an embodiment. A suggested private-party market price is then provided via pricing calculator and the provider designates the price as firm or negotiable.

A photo of the item may be posted and time slots for test drives may be posted as well with the post. In the meanwhile a preliminary exam is scheduled and the item status is listed as Available Soon. The preliminary exam is executed as is a formalities check, i.e., in the case of a vehicle, a check of title/lien records, and mileage is verified. More extensive photographic documentation may be made at this point as well.

In an optional embodiment, a reconditioning is scheduled and the providing endpoint renders a service fee (e.g., $199). Once a history report is run, the item is listed as For Sale.

At this point, the endpoints are now able to communicate and exchange data via application counterparts or via a website. As noted above, testing times are made available and during his communication phase, a testing time for the item is set. An automated process and calendar such as CrowdClock .ics file may be used.

The endpoints may converge at an SSP, whereupon the ID of the providing endpoint is verified and documentation associated with the taking endpoint such as ID and risk coverage, are verified and/or recorded.

The SSP may join the taking endpoint for the test in an embodiment, e.g., based on a request. The status of the item may be changed to reflect the test schedule. When a transaction price is agreed, and agreement is executed as to both endpoints. The agreed price is then held pending a secondary inspection process of the item, with the executed agreement being presented to the SSP prior to the secondary inspection.

The secondary inspection may be tailored based on the type of item in question. In an embodiment, the item is a vehicle, and the inspection is a 130 point (or more) inspection. In this scenario, the item may be given 1 of 3 possible grades, e.g., N (normal)—operating normally, MR (requires monitoring)—Showing some wear but serviceable, and AR (requires attention)—One or more important features or functions has failed or is failing. In the case of fluids, for example, replacement is required.

Staying with the given example of a vehicle, there are three possible outcomes after inspection, namely “no issues” (at which point the transaction concludes per agreement, or “issues noted” (Providing endpoint addresses all issues-noted on report and transaction concludes per agreement, or provider defers to address issues and agreement times out (becomes void). Alternatively, with issues noted, the endpoints may reconfigure one or more aspects of the transaction, e.g., amount.

In an embodiment, the provider cannot relist the item until the issues are resolve. The taking endpoint may provide warranty information and the SSP may include manufacturers recommended maintenance schedule and any required forms

The status of the item at this point is Inspected and the transaction, is free to close in a normal commercial manner. It will be appreciated that the SSP or app provider may offer warranty based or reconditioning services on inspection results and the SSP may extend its business by offering a continued service coupon book or the like. After the transaction closes, the item status is changed to Sold.

In an implementation, a database of recommended maintenance schedule information is made available to the application, and may be remotely accessed or stored locally. A database abstraction layer may be used to connect the database with the application on the internet connected device, and an application programming interface may provide a mechanism for automated data submission into the system.

Some interesting features of the disclosed system in various embodiments include possible online/app-based pre-screen of an item. In an embodiment, only items with less than a predefined number of prior owners, each having more than a minimum duration ownership can be listed via the application and system. Providing endpoints can self-qualify their items under these rules when they list the item, to be confirmed when the item is prescreened.

The pre-sale inspection also validates the providing endpoint's description and data or photos before public listing. In an embodiment, providers can agree to fixed pricing and may then not bargain or haggle with taking endpoints. Discounted reconditioning services such as bumper reconditioning, wheel reconditioning and scratch repair may be offered. In a further embodiment, all endpoints are associated with verified email addresses before contact is enabled.

It will be appreciated that a system and method for quickly and accurately executing an item transaction between a first endpoint and a second endpoint has been disclosed. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method of executing an item transaction between a first endpoint and a second endpoint via a transaction application running on a computing device, the computing device having a graphical user interface and one or more input functions, the method comprising:
receiving at the transaction application from the first endpoint data associated with an item to be subject to the transaction;
preparing a listing associated with the item at the transaction application and posting the listing while omitting a contact channel from the posting;
performing a verification and compensation process relative to the item and the first endpoint; and
in response to successful completion of the verification and compensation process, providing a contact channel between the first endpoint and the second endpoint so as to enable communications between the first endpoint and the second endpoint.
